(19) United States
(12) Patent Application Publication
(10) Pub. No.: US 2015/0245621 A1
(43) Pub. Date: Sep. 3, 2015

(54) HEADGEAR LINERS AND DISPOSABLE HEADGEAR LINERS

(71) Applicant: Laura Stewart, Manakin Sabot, VA (US)

(72) Inventor: Laura Stewart, Manakin Sabot, VA (US)

(21) Appl. No.: 14/633,425

(22) Filed: Feb. 27, 2015

Related U.S. Application Data
(60) Provisional application No. 61/946,187, filed on Feb. 28, 2014.

(51) Int. Cl. A01N 65/28; A01N 43/80; A01N 65/22; A01N 65/18; A42B 3/10; A43B 7/00

(52) U.S. Cl. CPC A01N 65/28; A42B 3/10; A43B 7/00; A01N 65/22; A01N 65/18; A01N 43/80

(57) ABSTRACT

Headgear liners are described that may be inserted into headgear prior to storage to remove moisture, deodorize, control odor, prevent fungus, and discourage insects, rodents and other pests from entering or remaining inside the helmet. The headgear liner may comprise a central portion and a plurality of petals extending from the central portion so the headgear liner may conform to that interior cavity of the headgear. In some embodiments, the headgear liner comprises of a nonwoven material with at least one essential oil impregnated into the non-woven material, wherein the essential oil provides beneficial properties to the liner.

### RELATED APPLICATIONS

This application claims priority under 35 U.S.C. §119 to U.S. Provisional Patent Application No. 61946.187 filed on Feb. 28, 2014.

### FIELD OF THE INVENTION

The invention relates to inserts for hats, helmets, other headgear, boots, and/or other footwear. The inserts remove moisture, deodorize, control odor, prevent fungus, and discourage insects, rodents and other pests from entering or remaining inside the helmet. Embodiments of the inserts are shaped to fit within and conform to the inside contours of a hat, helmet or other headgear.

### BACKGROUND

Hats, helmets and other headgear are commonly worn during sporting events such as, but not limited to, equestrian sports, golf, baseball, boxing, mixed martial arts, softball, hockey, football, cycling, motorcycling, skiing and snowboarding, and other sports for protection from impacts or exposure to the elements. Such headgear may get wet due to perspiration of the wearer or exposure to rain.

The exposure to moisture may cause mold, mildew or fungus to grow within the headgear causing odors and possible degradation of the padding or other components. Further, the headgear may be exposed to lice or other pests resulting in reintroducing the pests to the original wearer or transferring them to a second wearer.

There exists a need for a head gear liner that may be inserted in head gear between uses to reduce moisture, control odors, resists the growth of fungus and mold, and repel bugs and lice.

### SUMMARY

The liners including headgear liners may be inserted into headgear prior to storage. The headgear liner may comprise a central portion and a plurality of petals extending from the central portion. In some embodiments, the headgear liner comprises of a nonwoven material with at least one essential oil impregnated into the non-woven material, wherein the essential oil has insect repellant or other beneficial properties.

In another embodiment, the headgear liner comprises two essential oils wherein one essential oil is tea tree oil and the second essential oil is an essential oil other than tea tree oil. The essential oils include tea tree oil, lavender oil, peppermint oil, eucalyptus oil, lemon oil, orange oil, jasmine oil or combinations thereof.

### BRIEF DESCRIPTION OF THE DRAWINGS

FIG. 1 depicts an embodiment of the headgear liner comprising an oval central portion and eleven (11) oval shaped petals:

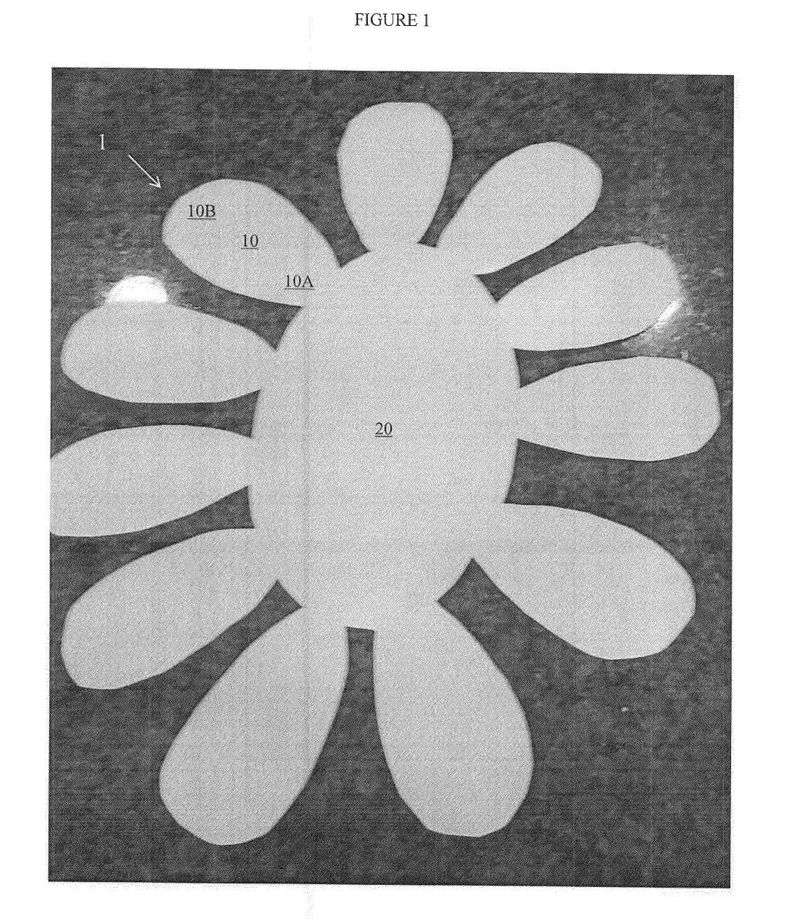

FIG. 2 depicts an embodiment of the headgear liner comprising a circular central portion and six truncated circular sectors shaped petals:

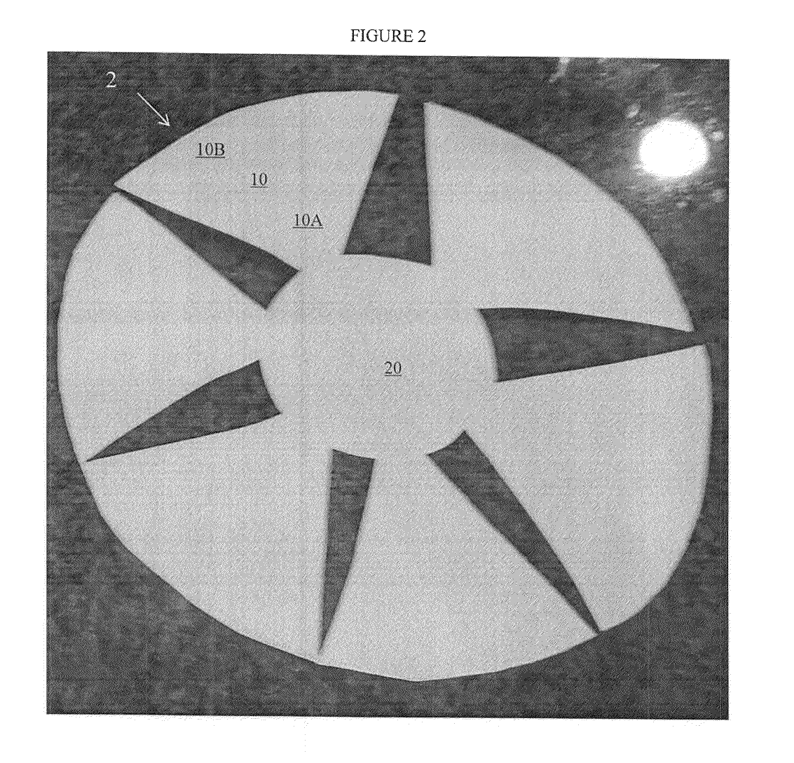

FIG. 3 shows the embodiment of the headgear liner of FIG. 1 inserted into a baseball helmet: and

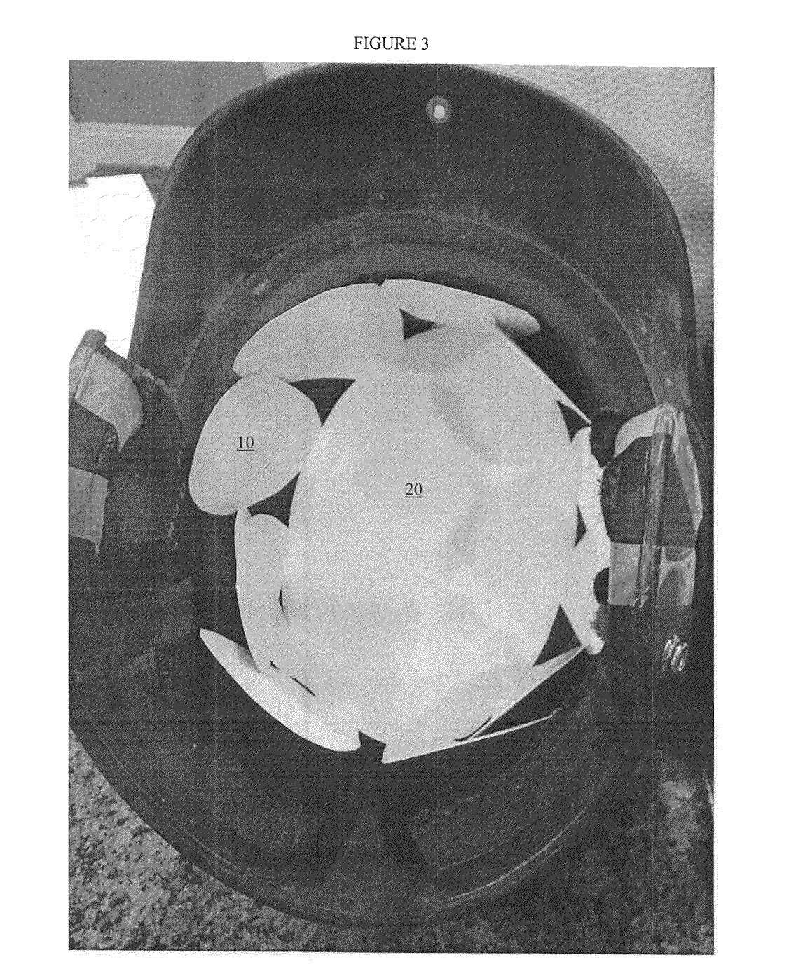

FIG. 4 shows the embodiment of the headgear liner of FIG. 2 inserted into a riding helmet.

### DESCRIPTION OF EMBODIMENTS OF THE INVENTION

Embodiments of a headgear liner are shaped to be easily conformable to lit into the internal cavity of headgear. Headgear comprises an internal cavity for receiving a head within the cavity during use. Various sizes and styles of headgear comprise different shapes and sizes of internal cavities. The internal cavities have a bottom portion that contacts or is adjacent to the top of the head during use and sides wherein at least a portion of the sides contact the sides of the head during use. The interior of the internal cavity is typically lined with liner layer or a foam protective liner (hereinafter “interior liners”). These interior liners may be become moist during use by sweat or rain, for example. The interior liners may hold this moisture resulting in odors, growth of mold and fungus, and degradation of the interior liner. Embodiments of the headgear liner may be fitted within the internal cavity at least partially in contact with the interior liner. The headgear liner may draw moisture from the interior liner, reduce or cover odors. In order to more fully contact the interior liner, further embodiments of the headgear liner may have a central portion and a plurality of petals extending from the central portion. The central portion will sit in the bottom of the cavity and the petals are capable of folding and conforming to the sides of the interior cavity of the headgear.

The headgear liner may be made of a fabric. The fabrics include, but are not limited to, nonwovens, polyester, polyethylene, polypropylene, acrylic, rayon, bamboo, cotton, wool/felt or combinations thereof, for example. The fabric may be a plastic nonwoven material. In a preferred embodiment, the nonwoven material may be a laminated plastic nonwoven. The laminated plastic nonwovens may be needle punched to enhance wicking, of moisture from the interior of the head gear and/or to control release of the impregnated liquids. In certain applications, the fibers may be antimicrobial fibers. The laminate of the laminated nonwoven may he a plastic material such as, but not limited to, polyethylene and polypropylene laminates.

Further. the headgear liner may be impregnated with natural or synthetic compounds to enhance its properties. The natural or synthetic compounds may include deodorants, desiccants, insecticide or pest repellant, solvents, emulsifiers, stabilizers, preservatives, solubilizers, anti-bacterials, anti-fungals, and/or other processing components. For example, embodiments of the headgear liner may comprise an essential oil or a combination of essential oils impregnated into fabric. In certain embodiments, the essential oil may have insect repellant properties. The essential oil may be any essential oil with the desired properties such as, but not limited to, tea tree oil, lavender oil, peppermint oil, eucalyptus oil, lemon oil, orange oil, jasmine oil or combinations thereof. In another embodiment, the liner comprises tea tree oil (melaleuca alternifolia) and a second essential oil. The second essential oil may be, but is not limited to, lavender oil, peppermint oil, eucalyptus oil, lemon oil, orange oil, jasmine oil or combinations thereof. In some embodiments, the tea tree oil may be in a ratio of between 3:7and 8:2 in relation to the second essential oil or oils. In other embodiments, the tea tree oil may be in a ratio of between 4:6 and 6:4 in relation to the second essential oil or oils.

The nonwoven may be impregnated or coated (“impregnated”) with the emulsion or solution by any known method such as, but not limited to, dipping, wet laying, spraying, or by microencapsulation, for example. The nonwoven may then be squeezed to remove excess liquid or heated to evaporate any excess water.

The liner may additionally be impregnated with an emulsion or solution comprising at least one of a solubilizer, the essential oil, and/or water to help evenly distribute the essential oil. The liner may be further impregnated with components that reduce the evaporation rate of the essential oils or other components, for example. In some embodiments. the emulsion or solution may comprise an alcohol. In some embodiments. the alcohol is one of ethyl alcohol and isopropyl alcohol and the emulsion or solution stabilizer is polysorbate 20. The liner may further be impregnated with an anti-bacterial, anti-fungal, and/or stabilizer.

A solubilizer may cause the essential oil or essential oils to be soluble in the carrier. The solubilizer may be castor oil, a nonionic ethoxylated surfactant, polyethylene glycol 40 hydrogenated castor oil, polypropylene glycol-26-buteth-26. and/or polysorbates such as polysorbate 20. The solubilizer may in a concentration sufficient to solubilize the essential oil in the carrier. The carrier may be water, for example. In specific embodiments, the solublizer may he in a concentration in the range of 1 weight % to 10 weight % of the entire solution, in a more specific embodiment, the solubilizer may be in a concentration in the range of 2 weight % to 5 weight % of the entire solution. Typically, solubilizers are added in a ratio of at least 2:1 of solubilizer to essential oil.

The anti-bacterial may he impregnated into the liner in sufficient concentration to prevent bacterial growth on and/or in the liner for the typical service life of one of the liners. The liners, typically, have a service life which may be as long as the time between uses which may be one to three weeks, the off season for the use of the helmet liner such as two to three months, for example, but may be as long as a year or, for long term storage, the service life may be longer. The anti-bacterial may he impregnated into the non-woven using the same solution used to impregnate the essential oil. In such embodiments, the anti-bacterial may be in a concentration in the range of 0.01 weight % to 1 weight % of the entire solution, in a more specific embodiment, the anti-bacterial may be in a concentration in the range of 0.02 weight % to 0.1 weight % of the entire solution. The concentration of the anti-bacterial is dependent on the efficacy of the anti-bacterial in the specific embodiment.

The anti-fungal may be impregnated into the liner in sufficient quantities to prevent growth of mold/fungus on and/or in the liner for the typical service life of one of the liners as described above. Similarly, the anti-fungal may be impregnated into the non-woven using the same solution used to impregnate the essential oil and/or the anti-bacterial. In such embodiments, the anti-fungal solubilizer may be in a concentration in the range of 0.01 weight % to 1 weight % of the entire solution. In a more specific embodiment. the anti-fungal may be in a concentration in the range of 0.02 weight % to 0.1 weight % of the entire solution. The concentration of the anti-fungal is dependent on the efficacy of the anti-fungal in the specific embodiment.

Thus, in one embodiment, the headliner comprises a nonwoven material. wherein the nonwoven is impregnated with a functional composition. The functional composition comprises a solubilizer in the range of 60 weight % to 85 weight % of the total weight of the functional composition. tea tree oil in the range of 10 weight % to 15 weight % of the total weight of the functional composition. second essential oil or oils in the range of 10 weight % to 15 weight % of the total weight of the functional composition, an anti-bacterial in the range of 0.5 weight % to 1.2 weight % of the total weight of the functional composition, and an antifungal in the range of 0.2 weight % to 0.8 weight % of the total Weight of the functional composition. The headliner may further comprise the carrier, such as water from the impregnation process.

The petals of the headgear liner may comprise a proximal end and a distal end. The proximal end is adjacent to the central portion. The petals and the central portion may be manufactured from a single piece of fabric or a plurality of pieces may be connected together to form the headgear liner. The pieces may be connected by stitching, adhesives, staples, hooks and loop connectors, or any other means for connecting the pieces sufficiently to remain connected as the headgear liner is inserted into or removed from the headgear between uses, for example.

The central portion of the headgear liner may be circular, oval, rectangular, square, or other shape preferably to conform to the shape of the bottom of the internal cavity of the headgear. The petals may also be in the shape of a circular sector, pie shaped, round, oval, rectangular or other shape to conform to the side walls of the internal cavity of the headgear. In additional embodiments, petals may have compound shapes such as a rectangular shape with wings or extensions that may wrap around the interior cavity of the headgear or other compound shape. For example, the headgear liner may comprise a central portion with two petals attached wherein the petals are arranged on opposite ends of the central portion and comprise extensions that wrap around the internal cavity of the head gear liner to contact each other. The shape of the petals may be such that the petals contact each other when the headgear liner is inserted into the cavity. This more complete coverage of the surface of the internal cavity ensures more contact to wick away moisture and repel pests from the entire cavity of the headgear.

The headgear liner may any desired number of petals. The number of petals may be from 2 to 20 petals. In some embodiments, for example in embodiments wherein the central portion of the headgear liner is circular or substantially circular the headgear liner may comprise from 4 to 10 petals or in more specific embodiments, the liner may comprise from 6 to 8 petals.

The headgear liner may comprise petals wherein the proximal end is narrower than a portion of the distal end of the petals. As such, when the headgear liner is inserted into the cavity of the headgear. the distal ends of the petals will contact each other forming a complete perimeter to the liner and protecting against insect infiltration.

In embodiments of the headgear liner comprising an oval or substantially oval central portion, the headgear liner may comprise 3 to 12 petals, for example. In more specific embodiments, the headgear liner may comprise 5 to 11 petals. The oval shape of the headgear liner allows more oval or flower petal shaped petals to be arranged around the perimeter of the central portion.

As described earlier. shape may be of a circular or oval pattern with center circle/oval and ‘petals’ branching off. For circular design, may have 6-8 petals. For oval designs, may have anywhere from 3-19 petals. Petals may start narrow and fan out wider at an edge or be elongated oval shapes. The diameter of circles may be anywhere from 11″-16″ and ovals in the range of 11″×19″. The liners may be designed in various shapes for applications other than headgear liners. For example, the liner may be cylindrical for insertion into a shoe or boot.

Fabrics may include, but are not limited to, polyester, acrylic, rayon, bamboo or wool/felt, nonwoven, and possibly plastic for further designs (boots/shoes/athletic gloves).

### EXAMPLE 1

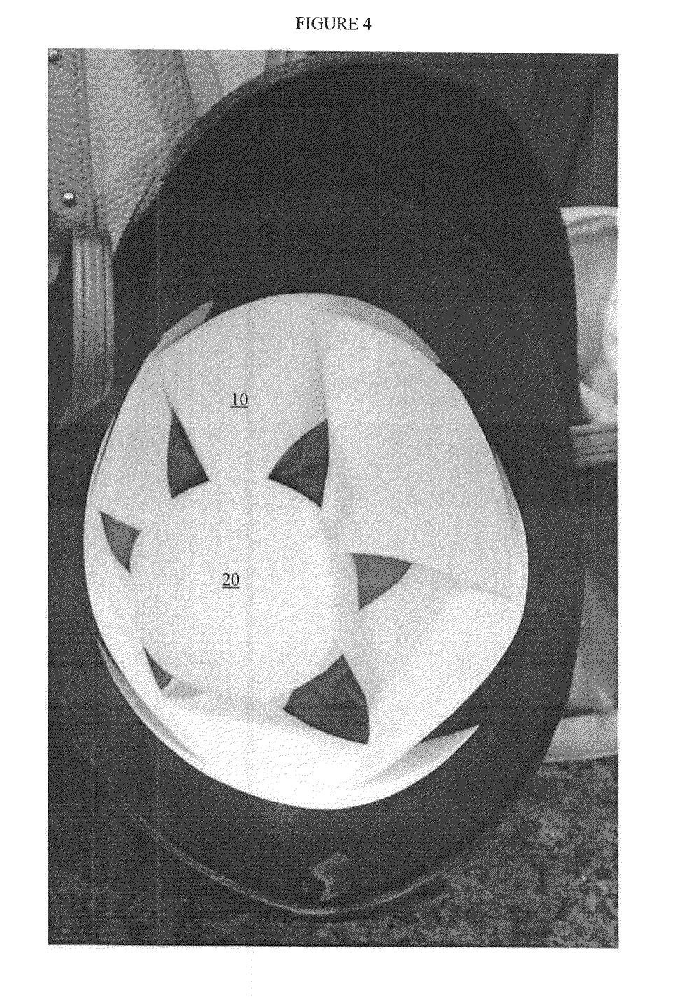

A headgear liner for a riding helmet was prepared as described herein and is shown in FIG. 4. The headgear liner comprises a central portion and six petals extending from the central portion. The six petals are slice of pie shaped with the narrow end connected to the oval central portion. The headgear liner is shown inserted into a riding helmet in FIG. 4 with the wider ends of the petals overlapping to conform to the shape of the inside surface of the helmet.

The headgear of FIG. 4 comprises a nonwoven material. In this embodiment the central portion and the petals were die cut from one sheet of nonwoven. The nonwoven has been impregnated with a solution comprising peppermint oil, 4% of castor oil (solubilizer. PEG-40 Hydrogenated castor oil (trade name ENRA.(11N EIRE-40™)), 0.05% of anti-bacterial (Methylisothiazolinone (trade name ACTICIDE M10™)) and 0.03% of anti-fungal (Octvlisothiazolionone (trade name ACTICIDE OWT™)).

As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising.” when used in this specification, specify the presence of stated features. steps. operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries. should be interpreted as having a meaning that is consistent with their meaning in the context of the relevant art and the present disclosure and will not be interpreted in an idealized or overly formal sense unless expressly so defined herein.

In describing the invention, it will be understood that a number of components, parts, techniques and steps are disclosed. Each of these has individual benefit and each can also be used in conjunction with one or more, or in some cases. All of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The embodiments of the headgear liner are not limited to the particular embodiments, components, method steps, and materials disclosed herein as such components, process steps, and materials may vary. Moreover, the terminology employed herein is used for the purpose of describing exemplary embodiments only and the terminology is not intended to he limiting since the scope of the various embodiments of the present invention will be limited only by the appended claims and equivalents thereof.

Therefore. while embodiments of the invention are described with reference to exemplary embodiments. Those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

1. A headgear liner, comprising:
a central portion:
a plurality of petals extending from the central portion, wherein the liner consists of a nonwoven material; and
an essential oil impregnated into the non-woven material, wherein the essential oil has insect repellant properties.

2. The headgear liner of claim 1, wherein the essential oil is tea tree oil and the nonwoven is impregnated with a second essential oil, wherein the second essential oil is different than the tea tree oil.

3. The headgear liner of claim 1, wherein the central portion is circular.

4. The headgear liner of claim 3, wherein the petals are oval shaped.

5. The headgear liner of claim 3, wherein the petals are slice of pie shaped.

6. The headgear liner of claim 5, wherein the petals are the shape of a circular sector shape.

7. The headgear liner of claim 5, wherein an outer perimeter of the headgear liner is circular having a first diameter and the petals are a circular sector of a circle having a second diameter.

8. The headgear liner of claim 7, wherein the first diameter is different than the second diameter.

9. The headgear liner of claim 1, wherein the liner comprises from 4 to 10 petals.

10. The headgear liner of claim 9, wherein the liner comprises from 6 to 8 petals.

11. The headgear liner of claim 2, wherein the petals comprise a proximal end and a distal end and the proximal end is narrower than the distal end of the petals.

12. The headgear liner of claim 1, wherein the liner comprises from 4 to 20 petals.

13. The headgear liner of claim 1, wherein the central portion of the liner is oval shaped.

14. The headgear liner of claim 13, wherein the petals are oval shaped.

15. The headgear liner of claim 14, wherein the liner comprises 4 to 11 petals.

16. The headgear liner of claim 1, wherein the essential oil is at least one of tea tree oil. lavender oil, peppermint oil, eucalyptus oil, lemon oil, orange oil, and jasmine oil.

17. The headgear liner of claim 2, wherein the liner is additionally impregnated with an solubilizer. an anti-bacterial and an anti-fungal.

18. The headgear liner of claim 2, wherein the second essential oil is at least one of lavender oil, peppermint oil, eucalyptus oil, lemon oil, orange oil, and jasmine oil.

19. The headgear liner of claim 17, wherein the solubilizer is a polysorbate.

20. A liner for headgear or footwear, comprising
a nonwoven material wherein the nonwoven is impregnated with a functional composition, wherein the functional composition comprises
a solubilizer in the range of 60 weight % to 85 weight % of the total weight of the functional composition.
tee tree oil in the range of 10 weight % to 15 weight % of the total weight of the functional composition.
second essential oil or oils in the range of 10 weight % to 15 weight % of the total weight of the functional composition.
an anti-bacterial in the range of 0.5 weight % to 1.2 weight % of the total weight of the functional composition. and
an antifungal in the range of 0.2 weight % to 0.8 weight % of the total weight of the functional composition.
